(19) United States
(12) Patent Application Publication
(10) Pub. No.: US 2026/0201853 A1
(43) Pub. Date: Jul. 16, 2026

(54) Joint for Rocket Motor

(71) Applicant: Ursa Major Technologies, Inc., Berthoud, CO (US)

(72) Inventors: Steven Alexander Leverette, Denver, CO (US); Arek Brian Stanton, Boulder, CO (US)

(21) Appl. No.: 19/214,038

(22) Filed: May 21, 2025

Related U.S. Application Data
(60) Provisional application No. 63/744,125, filed on Jan. 10, 2025.

(51) Int. Cl. F02K 9/34

(52) U.S. Cl. CPC F02K 9/343

(57) ABSTRACT

A joint for a rocket motor provides a seal for an end cap disposed at a fore end of the rocket motor. The joint includes a casing and a plurality of ring retainers. The casing is of a cylindrical shape. The casing includes a set of engagement holes disposed circumferentially around the fore end of the casing. The plurality of ring retainers is coupled to an inner surface of the casing. Each ring retainer includes a set of pins extending from an outer surface of the ring retainer. The set of pins of the ring retainer extend in a parallel configuration to engage with a subset of the engagement holes of the casing.

### CROSS-REFERENCE TO RELATED APPLICATIONS

The present application claims the benefit of and priority to U.S. Provisional Application No. 63/744,125 filed on Jan. 10, 2025, which is incorporated by reference in its entirety.

### BACKGROUND

Solid propellant rocket motors typically cast propellant cartridges into a tubular shaped outer casing. Larger cartridges allow for increased capacity for propellant, yielding greater power for propulsion systems. This increased capacity for propellant results in higher thrust, longer burn times, and extended operational ranges crucial for rocket motors. Designing a system that compactly fits a large cartridge into a compact outer casing offers a unique design solution ideal for space-constrained applications.

### SUMMARY

A joint for a cartridge system is designed to optimize fastening methods in rocket motors. The joint for the cartridge system includes an outer casing of a cylindrical shape to enclose a propellant of the rocket motor. The outer casing comprises a set of engagement holes disposed circumferentially around one end of the rocket's outer casing. The joint for the cartridge system includes a set of ring retainers coupled to an inner surface of the outer casing. The ring retainer is positioned between the cartridge system and the outer casing. The ring retainer includes a set of pins extending from an outer surface of the ring retainer, wherein the set of pins of the ring retainer extend in a parallel configuration to engage with a subset of the engagement holes of the casing. This engagement causes self-supporting geometry, establishing a direct load-bearing relationship between the cartridge and the outer casing.

### BRIEF DESCRIPTION OF THE DRAWINGS

FIG. 1 illustrates a manufacturing system environment, according to one or more embodiments.

FIG. 2 illustrates a block diagram of a design system, according to one or more embodiments.

FIG. 3A illustrates a perspective view a solid propellant rocket motor, according to one or more embodiments.

FIG. 3B illustrates a cross-sectional view of the solid propellant rocket motor of FIG. 3A, according to one or more embodiments.

FIG. 4A illustrates an additional perspective view of the solid propellant rocket motor 300, according to one or more embodiments.

FIG. 4B illustrates a perspective of a propellant cartridge, according to one or more embodiments.

FIG. 4C illustrates a perspective view of a forward bulkhead, according to one or more embodiments.

FIG. 4D illustrates a perspective view of a ring retainer, according to one or more embodiments.

FIG. 4E illustrates an additional perspective view of a ring retainer, according to one or more embodiments.

FIG. 4F illustrates a perspective view of a ring retainer fastened to an outer casing, according to one or more embodiments.

FIG. 4G illustrates a cross-sectional view of the forward bulkhead of FIG. 4C, according to one or more embodiments.

FIG. 4H illustrates a perspective view of the forward bulkhead of FIG. 4C, according to one or more embodiments.

FIG. 4I illustrates a cross-sectional view of the forward bulkhead of FIG. 4C, according to one or more embodiments.

### DETAILED DESCRIPTION

### System Environment

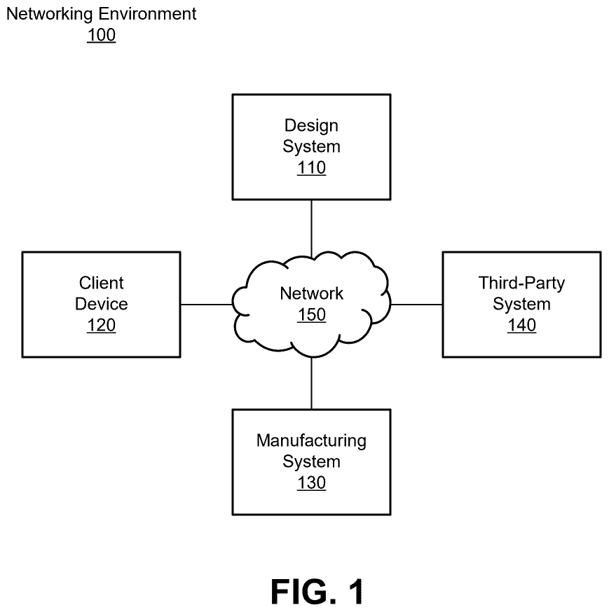

FIG. 1 illustrates a manufacturing system environment 100, according to one or more embodiments. The environment 100 includes a design system 110, a client device 120, a manufacturing system 130, and a network 140. In other embodiments, the environment 100 may include additional systems and/or devices, e.g., one or more third-party systems which may provide data useful to the other systems in the networking environment 100. In other embodiments, the functionality described may be interchangeably performed by other systems and/or devices.

The design system 110 generates a design for a rocket motor 300 and/or a specific process with parameters tuned for a particular rocket motor design. The design system 110 may receive design objectives to guide the design of the rocket motor 300. The design objectives may specify the physical characteristics of the rocket motor 300 (e.g., height, width, weight, choice of propellant, etc.), a thrust profile to be achieved by the rocket motor 300, or other mission-specific criteria. Example design objectives may include: thrust-time profile, specific impulse, total impulse, combustion chamber pressure, structural loads, etc. The design system 110 may leverage one or more heuristics to generate the design for the rocket motor 300 based on the input parameters. Design parameters that may be determined by the design system 110 include: physical characteristics of the rocket motor 300, propellant type and composition, grain amount and geometry, nozzle design (e.g., convergent-divergent profile, throat diameter, exit diameter), casing material and/or thickness, ignition assembly characteristics.

In some embodiments, the design system 110 may leverage one or more models for simulating the performance of a design. The one or more models may be physics-based simulators. For example, the design system 110 may leverage models based on computational fluid dynamics (CFD), finite element analysis (FEA) to simulate complex flow and structural behavior, or other like models. The one or more models may be further tuned based on experimental results. For example, the manufacturing system 130 may measure characteristics and attributes of a rocket motor 300 manufactured according to a design. Based on the measured characteristics (e.g., thrust, total impulse, specific impulse, dynamic force, dynamic pressure, static pressure, burn profile, etc.), the design system 110 may compare those measured characteristics to the target parameters expected by the design. The design system 110 may refine the models by using training examples generated from the measured characteristics against the predicted characteristics, i.e., in a supervised learning fashion.

In one or more embodiments, the design system 110 may generate a plurality of candidate designs that fit the target design objectives. The design system 110 may use the one or more simulation models to score simulated performance of the different designs. The design system 110 may select one or more of the candidate designs based on the scores for manufacturing and experimentation.

The design system 110 may present the one or more designs, with expected performance metrics to a user involved with the rocket motor 300 design process, e.g., on a graphical user interface. The user may provide input to modify the one or more designs, or selection to proceed with manufacturing one or more of the designs. In response, the design system 110 may perform the requested modifications to the design. The design system 110 may re-simulate the rocket motor 300 performance and provide updates to the simulated metrics to the user. The design system 110 may leverage this iterative process to achieve a final design for the rocket motor 300.

The design system 110 may also determine a manufacturing workflow for a designed rocket motor 300. The design workflow may set adjustable manufacturing parameters to achieve the target design. The design system 110 may determine the manufacturing workflow based on industry standards, best practices, or regulatory constraints. In some embodiments, the design system 110 may include inspection points for the manufacturing system 130 to request operator inspection approval prior to progressing to the next step in the manufacturing workflow.

The client device 120 is a computing device in use by a user. The user may be one involved in the design of the rocket motor 300. In such embodiments, the user may provide input and guidance on the design of a rocket motor 300. The client device 120 may present a graphical user interface embodied as a design platform for inputting design objectives for the rocket motor 300. Based on the user input, the client device 120 may present, e.g., in the graphical user interface, updates to simulated performance metrics, e.g., determined by the design system 110.

In other embodiments, the user may be a manufacturing operator, tasked with overseeing the manufacturing process. In such embodiments, the client device 120 may provide updates on progress of the manufacturing process, e.g., provided by the manufacturing system 130. As part of the progress updates, the client device 120 may present images or other information on the rocket motor 300, e.g., for quality inspection and control by the user.

The manufacturing system 130 may include one or more machines operable in an autonomous and/or manual manner. The machines work in conjunction to manufacture a rocket motor 300 according to a manufacturing workflow and design parameters of a rocket motor 300 design determined by the design system 110. Some machines may be configured to construct components of the rocket motor 300. In one or more embodiments, the manufacturing system 130 may include a three-dimensional (3D) printing machine, capable of constructing physical structures through a 3D printing process. In other embodiments, the manufacturing system 130 may include a machine for spray-on coating material onto surfaces of other structures. Some machines may be configured to cure or otherwise treat the rocket motor 300, e.g., to aid in bonding of components together. Some machines may be configured to excise or to remove material, e.g., via drilling, milling, laser cutting, washing away material with solvent, etc. Some machines may be configured to measure characteristics of the constructed rocket motor 300, e.g., during various stages of the manufacturing workflow. For example, an x-ray imaging device may be configured to emit x-rays for imaging the internal structure of a completed rocket motor 300.

In one or more example implementations, the manufacturing system 130 includes a selective laser melting (SLM) printer. The SLM printer builds metal parts layer by layer using a high-power laser to selectively melt and fuse metallic powders. The system includes a build chamber, a powder delivery system, a laser system, and a control system. The build chamber is a sealed environment typically filled with inert gas (like argon or nitrogen) to prevent oxidation during the melting process. The powder delivery system uses a recoater blade or roller to spread a thin, uniform layer of metal powder across the build platform. The laser system, guided by a design for a component to be manufactured, precisely scans the powder bed, melting the powder particles together to form a solid layer. After each layer is completed, the build platform lowers, and the recoater spreads another layer of powder, repeating the process until the entire part is built. Unmelted powder remains in the powder bed and acts as support for the part during the build process, which may later be removed and reused. A direct metal laser sintering (DMLS) printer operates in a similar manner, but sinters particles together without melting the particles.

In one or more example implementations, the manufacturing system 130 includes a sand 3D printer. The sand 3D printer can create sand structures, e.g., for molds and cores. The sand 3D printer includes a build box, a recoating system, and a printing mechanism. The build box is a container holding the fine silica sand that serves as the printing medium. The recoating system, typically a blade or roller, spreads a thin, even layer of sand across the build platform after each printing pass. The printing mechanism includes a printhead which precisely dispenses a liquid binder onto the sand bed. This binder selectively bonds the sand grains together according to a digital design. A control system manages the movement of the printhead and the recoating system, for accurate and precise layer deposition. The printing process involves the printhead selectively depositing binder onto the sand, layer by layer, until the desired mold or core is formed. Unbound sand remains in the build box to support the printed object during the build process and is later removed.

In one or more example implementations, the manufacturing system 130 includes a 3D printer for forming plastic structures, e.g., for molds and cores. The 3D printer includes a build box, and a printing mechanism. The build box is a container holding the structure as the print material is extruded onto a platform of the build box. In implementations with thermoplastics, the printing mechanism deposits the print material, which may be a spool of plastic filament, that is fed into a nozzle that melts the filament when extruding onto the platform. A control system manages the movement of the nozzle, for accurate and precise deposition of the print material.

In one or more example implementations, the manufacturing system 130 includes a spray-on coating system. The spray-on coating system may be used for spraying on material to form one or more layers in the rocket motor 300 manufacturing process, e.g., applying ethylene propylene diene monomer (EPDM) to create a thin, uniform layer. The spray-on coating system includes a material supply system, a mixing unit, a spray nozzle, an air compressor, and a control system. The material supply system, which may include one or more containers and one or more pumps, stores and delivers the liquid material, which may often be in a two-part formulation that is mixed just prior to application. The mixing unit ensures proper homogenization of the material. The spray nozzle disperses the mixed material, e.g., by atomizing the liquid into a fine spray. The air compressor or other propellant system provides the pressure to atomize and propel the liquid material through the spray nozzle. The control system manages the material flow rate, air pressure, and spray pattern to achieve the desired coating thickness and uniformity. The spray-on coating system may continue to deposit liquid material, layer by layer, to achieve the desired thickness.

In one or more example implementations, the manufacturing system 130 includes a filament winder. The filament winder is a machine used to create composite structures by winding continuous filaments, e.g., fiberglass, carbon fiber, or aramid fiber, around a rotating mandrel. The system includes a creel, a tensioning system, a resin bath or impregnation system, and a control system. The creel holds multiple spools of the filament material, feeding them into the winding process. The tensioning system controls the tension of the filaments as they are unwound, for consistent fiber placement and for preventing slack or breakage. The resin bath or the impregnation system coats the filaments with resin, which acts aids in binding layers of fiber together. A rotating headstock holds the mandrel during the filament winding process. In some implementations, a carriage is used, guided by the control system, to move along the length of the mandrel, laying down the resin-impregnated filaments in a predetermined pattern. The control system coordinates the rotation of the mandrel and the movement of the carriage to achieve the desired winding angle and fiber distribution, creating a strong and lightweight composite structure.

In one or more example implementations, the manufacturing system 130 includes an oven for curing the rocket motor 300, at one or more stages of the manufacturing process. The oven includes a chamber and one or more heating elements. The heating elements heat up the chamber to a desired temperature. In some implementations, the oven may further include a vacuum pump to generate a vacuum within the chamber.

In one or more embodiments, the manufacturing system 130 includes one or more sensing machines for measuring characteristics of the rocket motor 300, e.g., during various stages of manufacture. For example, the manufacturing system 130 may include one or more pressure sensors (e.g., a load cell) for measuring thrust by the rocket motor 300. The pressure sensors may be positioned at the fore end of the rocket motor 300. As the rocket motor 300 is ignited, the pressure sensors measure the force applied by the rocket motor's propulsion. In other examples, pressure sensors may be coupled to various points of the rocket motor 300 casing to measure pressure on various points of the combustion chamber, e.g., during combustion. In another example, the manufacturing system 130 may include one or more temperature sensors (e.g., thermocouples) for measuring temperature at one or more points of the rocket motor 300. Other examples include accelerometers to measure vibrations or other combustion instabilities.

The network 140 is a collection of computing devices that communicate via wired or wireless connections. The network 140 may include one or more local area networks (LANs) or one or more wide area networks (WANs). The network 140, as referred to herein, is an inclusive term that may refer to any or all of the standard layers used to describe a physical or virtual network, such as the physical layer, the data link layer, the network layer, the transport layer, the session layer, the presentation layer, and the application layer. The network 140 may include physical media for communicating data from one computing device to another computing device, such as multiprotocol label switching (MPLS) lines, fiber optic cables, cellular connections (e.g., 3G, 4G, or 5G spectra), or satellites. The network 140 also may use networking protocols, such as TCP/IP, HTTP, SSH, SMS, or FTP, to transmit data between computing devices. In some embodiments, the network 140 may include Bluetooth or near-field communication (NFC) technologies or protocols for local communications between computing devices. The network 140 may transmit encrypted or unencrypted data.

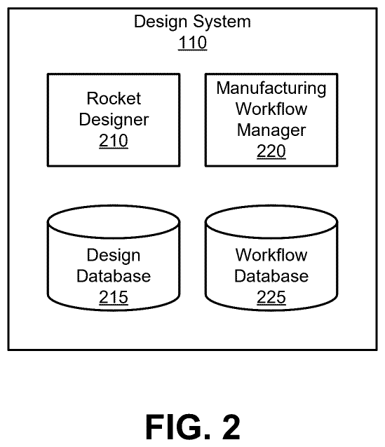

FIG. 2 illustrates a block diagram of the design system 110, according to one or more embodiments. The design system 110 includes a rocket design module 210, a manufacturing workflow management module 220, a design database 215, and a workflow database 225. In other embodiments, the design system 110 may include additional, different, or fewer components than those listed herein. In other embodiments, the functionality of the various components may be disparately distributed.

The rocket design module 210 generates one or more designs for rocket motors 300. In some embodiments, the rocket design module 210 generates and presents to a client device a user interface to aid in design of the rocket motor 300. The user may, via the interface presented on the client device, input design parameters. To design the rocket motor 300 design, the rocket design module 210 may leverage templates from the design database 215. The templates may provide a baseline shape and geometry, the dimensions of which may be adjustable to achieve particular design parameters. The interface may further present data to the user, e.g., predicted characteristics of the rocket. The rocket design module 210 may leverage one or more models for calculating aerodynamic properties, stability margins, and flight simulations based on chosen components and propellant characteristics. The module may further leverage modeling tools to estimate characteristics or attributes of the rocket motor 300, e.g., flight trajectory simulations, and integration with computational fluid dynamics (CFD) software for more detailed aerodynamic analysis. The rocket design module 210 provides the design to the manufacturing workflow management module 220 to generate a protocol for manufacturing a rocket motor 300 according to the design.

The manufacturing workflow management module 220 generates the protocol based on the design, e.g., designed by the rocket design module 210. The manufacturing workflow management module 220 may leverage one or more templates for generating the protocol, e.g., stored in the workflow database 225. The templates may include steps and substeps for the protocol. For example, based on the volume of propellant grain cast and/or a geometry of the rocket motor, the workflow database 225 may store a look-up table for determining a cure time and temperature for operating an oven. The manufacturing workflow management module 220 manages the sequence of manufacturing steps, e.g., including material procurement, component fabrication, assembly, and testing. The manufacturing workflow management module 220 may modify the protocol based on quality inspection. The manufacturing workflow management module 220 may assign tasks in the protocol to personnel or machines. The manufacturing workflow management module 220 may communicate with the manufacturing system 130 to track progress of the protocol. The manufacturing workflow management module 220 may integrate with computer-aided manufacturing (CAM) software for generating toolpaths for CNC machining or other manufacturing processes. The manufacturing workflow management module 220 may also track results of quality control checkpoints and may manage documentation related to the manufacturing process, crafting a manufacturing log detailing quality control throughout the protocol.

The design database 215 is a central repository for all design-related data and/or information. The design database 215 may store CAD models, design templates, drawings, specifications, material properties, test results, models used for rocket design, and other design documents. Past designs may be stored in the design database 215.

The workflow database 225 stores information related to the manufacturing workflow. The workflow database 225 may store data tracking status of each manufacturing step, including start and end times, sign off from personnel, any issues encountered, or some combination thereof. The workflow database 225 may further store workflow templates used for generating the protocols. The workflow database 225 may provide real-time visibility into the production process, empowering operators to identify bottlenecks, track progress against schedules, make informed decisions to optimize efficiency, or some combination thereof. The workflow database 225 may also store logs of past manufacturing runs, which can be used for process improvement and troubleshooting.

### Rocket Motor

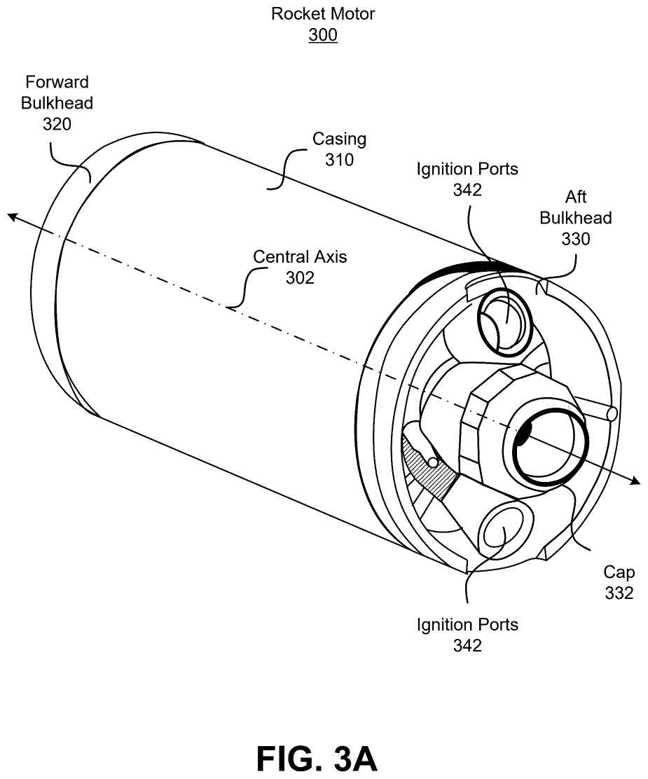

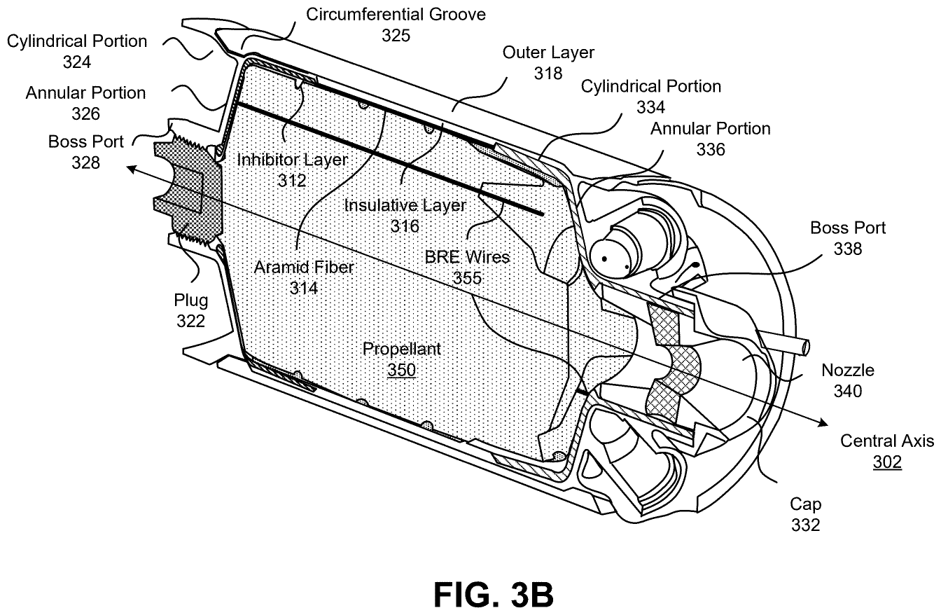

FIGS. 3A & 3B illustrate a solid propellant rocket motor 300, according to one or more embodiments. FIG. 3A shows the rocket motor 300 in a perspective view. FIG. 3B shows a cross-section of the rocket motor 300, with its various internal components. For reference, a central axis 302 extends through a center of a fore end and a center of a back end of the rocket motor 300. In one or more embodiments, the rocket motor 300 is cylindrical in shape. In other embodiments, the rocket motor 300 may be conical in shape. The rocket motor 300 may have radial symmetry, along the central axis 302.

The rocket motor 300 may be a solid rocket motor that is designed to carry propellant grain within the combustion chamber. While solid rocket motors are used as the primary examples in this disclosure, various structures and manufacturing processes described in this disclosure may also be applied to other types of rocket motors that carry other types of propellants, such as liquid rocket engines, hybrid rocket motors, and other thrusters. In some embodiments, the rocket motor 300 may also be generally referred to as a rocket engine, a thruster, or a propulsion device. In various embodiments, a rocket motor 300 may be paired with any type of vehicle that uses a propulsion system, such as a missile, a space launch vehicle, a satellite launcher, or another suitable rocket. The rest of the vehicle is not shown in this disclosure.

The rocket motor 300 is composed of a casing 310, a forward bulkhead 320, an aft bulkhead 330, and one or more internal components. The casing 310, the forward bulkhead 320, and the aft bulkhead 330 form a combustion chamber for the combustion of propellant to generate propulsion from the rocket motor 300. The combustion chamber is accessible via one or more ports. One or more ports may be configured to inject an ignition charge to begin combustion of the propellant disposed in the combustion chamber. One port, i.e., a nozzle 340, may be configured to exhaust gas from the combustion of the propellant. The exhaust of the gas creates a propulsion force opposite to the direction of the nozzle. Disposed within the combustion chamber may include the one or more internal components. In one or more embodiments, the internal components include propellant, and, optionally, one or more burn rate enhancing (BRE) wires.

The casing 310 forms a surrounding wall to the combustion chamber. The casing 310 may be composed of a plurality of layers. The casing 310 may include one or more insulative layers, and one or more layers for adding rigidity to the casing 310. In one or more embodiments, the casing 310 includes an inhibitor layer 312, an aramid fiber layer 314, an insulative layer 316, and an outer layer 318.

The inhibitor layer 312 couples to the propellant grain 350 in the combustion chamber of the rocket motor 300. The inhibitor layer 312 is formed of a non-combustible material. The inhibitor layer 312 may act as an insulative barrier, i.e., the inhibitor layer may also be referred to as an insulative layer. As such, any surface of the propellant grain 350 that is coupled to the inhibitor layer 312 is protected from combustion. By protecting the circumferential surface of the propellant grain 350, the inhibitor layer 312 controls the combustion of the propellant grain 350. The inhibitor layer 312 may include one or more topographical features for communication of gas from along the side wall of the combustion chamber. The topographical features help to dissipate pressure generated during combustion of the propellant. In one or more embodiments, the topographical features include grooves. One or more grooves may be linear, running lengthwise, from the fore end to the aft end of the combustion chamber. One or more grooves may be curved, e.g., running circumferentially around the inhibitor layer 312. In one or more embodiments, the grooves may form a mesh pattern on a surface of the inhibitor layer 312. In other embodiments, the grooves may form other hashed patterns on the surface. In one or more embodiments, the inhibitor layer 312 is spray coated onto the surface of the propellant grain 350.

The aramid fiber layer 314 adds strength to the casing 310. The aramid fiber layer 315 may be composed of an aramid fiber woven into a fabric. The aramid fiber is a synthetic fiber, i.e., manufactured from aromatic polyamide. The aramid fiber may be synthetic, heat-resistant, strong, or some combination thereof. The aramid fiber layer 314 may be composed of a single or multiple layers of the aramid fiber fabric. The multiple layers may be coupled together with an adhesive, through chemical treatment, some other manner of adherence, or some combination thereof. In one or more embodiments, the aramid fiber layer 314 is wound onto the propellant grain 350 and the inhibitor layer 312. In other embodiments, the aramid fiber layer 314 is wound on a mold of the combustion chamber. The aramid fiber layer 314 is coupled to the inhibitor layer 312. The aramid fiber layer 314 provides for relative movement of the propellant grain 350 separate from the insulative layer 312, e.g., during the initial pressurization event early on during combustion.

The insulative layer 316 provides heat insulation to the casing 310. The insulative layer 316 is composed of a heat-resistant material. The insulative layer 316 may be, e.g., composed of ethylene propylene diene monomer (EPDM), or some other synthetic rubber compound. The insulative layer 316 may be sprayed onto the aramid fiber layer 314.

The outer layer 318 provides structure to the casing 310. The outer layer 318 is composed of a material with high strength, e.g., tensile strength above 3,500 megapascals (MPa). In one or more embodiments, the outer layer 318 is composed of metal, or a metallic alloy. In other embodiments, the outer layer 318 is composed of one or more layers of carbon fiber. In such embodiments, the carbon fiber may be wound onto the insulative layer 316 and portions of the forward bulkhead 320 and the aft bulkhead 330. The carbon fiber layers may be bound with epoxy. The casing 310, the forward bulkhead 320, and the aft bulkhead 330 may be cured in an oven to bound one or more of the layers together.

The forward bulkhead 320 has a cylindrical portion 324, an annular portion 326, and a boss port 328. The cylindrical portion 324 of the forward bulkhead 320 has a radius less than the casing 310, such that a fore portion of the casing 310 wraps circumferentially around an external surface of the cylindrical portion 324 of the forward bulkhead 320. The cylindrical portion 324 includes a circumferential groove 325 disposed in between the fore end and the aft end of the cylindrical portion 324. The radius of the circumferential groove 325 (as measured radially from the central axis 302) is smaller than a radius of the aft end of the cylindrical portion 324. The casing 310 is wound onto the circumferential groove 325, providing grip to prevent decoupling of the forward bulkhead 320 and the casing 310 during combustion.

An outer circumference of the annular portion 326 is coupled to an internal surface of the cylindrical portion 324, opposite the external surface of the cylindrical portion 324. The annular portion 326 may be approximately perpendicular to the cylindrical portion 324, i.e., an angle formed between the annular portion 326 and the cylindrical portion 324 is within the range of 75°-105°. The projected apex of the annular portion 326 is disposed along the central axis 302 towards the fore end of the rocket motor 300. In other embodiments, the annular portion 326 may be planar. A radius of the annular portion 326 may be more than half of the radius of the forward bulkhead 320, as measured radially from the central axis. As such, the diameter of the internal circumference of the annular portion 326 may be less than half of the diameter of the forward bulkhead 320, measured perpendicular to the central axis 302.

An aft end of the boss port 328 is coupled to the internal circumference of the annular portion 326. The boss port 328 is cylindrical in shape. The boss port 328 includes threading on an internal surface of the boss port 328. In other embodiments, the threading of the boss port 328 may be disposed on the external surface. A diameter of the boss port 328 is approximately equal to the diameter of the internal circumference of the annular portion 326.

A plug 322 is coupled to the boss port 328 of the forward bulkhead 320. In one or more embodiments, the plug 322 includes threading on an external surface of the plug 322. The threading on the plug 322 is complementary to the threading of the boss port 328. In other embodiments, the plug 322 may be cylindrical in shape with threading on an internal surface of the plug 322. In such embodiments, the plug 322 may be sized greater than the boss port 328, such that the plug 322 couples over the boss port 328. In other embodiments, the plug 322 may be coupled to the boss port 328 in another fashion, e.g., welded, bonded, secured with a mechanical fastener, etc. The threading of the plug 322 and the threading of the boss port 328 is dimensioned to withstand the pressure in the combustion chamber during combustion of the propellant, e.g., to withstand the shear stress.

In one or more embodiments, the forward bulkhead 320 may be monolithic. A monolithic structure is advantageous in that there are no weak points in the structure due to coupling of disparate parts. To achieve the monolithic structure, the forward bulkhead 320 may be machined from a single piece of material, three-dimensional (3D) printed, or some combination thereof. For example, the forward bulkhead 320 may be machined with Computer Numerical Control (CNC) machining that leverages a computer system to precisely control machinery to remove material from a single piece of material. The computer system may generate instructions for controlling the machinery to exacting precision. In another example, the forward bulkhead 320 may be 3D printed with an additive process. Likewise, the 3D printer leverages a computer system for precise control of the 3D printer's components for precise addition of material to build a structure. In one or more embodiments, Selective Laser Melting (SLM) or Direct Metal Laser Sintering (DMLS) are two example metal additive manufacturing processes that both leverage a laser to scan and selectively fuse metal powder particles together, thereby bonding the metal powder particles into one monolithic structure.

The aft bulkhead 330 has a cylindrical portion 334, an annular portion 336, and a boss port 338. The cylindrical portion 334 of the aft bulkhead 330 has a radius less than the casing 310, such that an aft portion of the casing 310 wraps circumferentially around an external surface of the cylindrical portion 334 of the aft bulkhead 330. The cylindrical portion 334 includes a circumferential groove 335 disposed in between the fore end and the aft end of the cylindrical portion 334. The radius of the circumferential groove 325 (as measured radially from the central axis 302) is smaller than a radius of the aft end of the cylindrical portion 334. The casing 310 is wound onto the circumferential groove 335, providing grip to prevent decoupling of the aft bulkhead 330 and the casing 310 during combustion.

An outer circumference of the annular portion 336 is coupled to an internal surface of the cylindrical portion 334, opposite the external surface of the cylindrical portion 334. The annular portion 336 may be approximately perpendicular to the cylindrical portion 334, i.e., an angle formed between the annular portion 336 and the cylindrical portion 334 is within the range of 75°-105°. The projected apex of the annular portion 336 is disposed along the central axis 302 towards the aft end of the rocket motor 300. In other embodiments, the annular portion 336 may be planar. A radius of the annular portion 336 may be more than half of the radius of the aft bulkhead 330, as measured radially from the central axis. As such, the diameter of the internal circumference of the annular portion 336 may be less than half of the diameter of the aft bulkhead 330, measured perpendicular to the central axis 302.

An aft end of the boss port 338 is coupled to the internal circumference of the annular portion 336. The boss port 338 is cylindrical in shape. The boss port 338 includes threading on an external surface of the boss port 338, towards an aft end of the boss port 338. In other embodiments, the threading of the boss port 338 may be disposed on the internal surface. A diameter of the boss port 338 is approximately equal to the diameter of the internal circumference of the annular portion 336.

A cap 332 is coupled to the boss port 338 of the aft bulkhead 330. In one or more embodiments, the cap 332 includes threading on an internal surface of the cap 332. In such embodiments, the cap 332 may be sized greater than the boss port 338, such that the cap 332 couples over the boss port 338. The threading on the cap 332 is complementary to the threading of the boss port 338. In other embodiments, the cap 332 may be cylindrical in shape with threading on an internal surface of the cap 332. In other embodiments, the cap 332 may be coupled to the boss port 338 in another fashion, e.g., welded, bonded, secured with a mechanical fastener, etc. The threading of the cap 332 and the threading of the boss port 338 is dimensioned to withstand the pressure in the combustion chamber during combustion of the propellant, e.g., to withstand the shear stress.

A nozzle 340 is disposed within the boss port 338 of the aft bulkhead 330. The nozzle 340 is sized with an external dimension to fit snuggly into the boss port 338 of the aft bulkhead 330. As such, an external surface of the nozzle 340 is complementary to the internal surface of the boss port 338. The nozzle 340 has an internal surface with curvature that forms a throat, defined as the minimal radial cross-sectional opening in the nozzle 340. Exhaust gas is choked at the throat prior to being expelled from the nozzle 340. A ratio of the cross-sectional area of the exit of the nozzle 340 and the cross-sectional area of the throat of the nozzle 340 dictates the propulsion force. In one or more embodiments, the internal surface of the nozzle 340 converges from the combustion chamber towards the throat and diverges from the throat towards the exit of the rocket motor 300.

In one or more embodiments, the aft bulkhead 330 includes one or more ignition ports 342 for igniting the propellant in the rocket motor 300. In one or more embodiments, the ignition ports 342 are slanted from the central axis 302. In the embodiment shown in FIG. 3, the aft bulkhead 330 includes two ignition ports diametrically positioned on either side of the central axis 302. The ignition ports 342 provide access to the combustion chamber for an ignition assembly to ignite the propellant. In one or more embodiments, the ignition assembly may be configured as a through-bulkhead initiator (TBI) which leverages a detonation shockwave to initiate the deflagration of a pyrotechnic composition. In other embodiments, the ignition assembly may be configured as an electrical device that uses an electric current to heat up a wire inside the combustion chamber, to ignite the propellant. Other manners of ignition may be implemented. In other embodiments, a single ignition port 342 is positioned on the aft bulkhead 330, with the ignition assembly disposed within the ignition port 342.

In one or more embodiments, the aft bulkhead 330 may be monolithic. A monolithic structure is advantageous in that there are no weak points in the structure due to coupling of disparate parts. To achieve the monolithic structure, the aft bulkhead 330 may be machined from a single piece of material, three-dimensional (3D) printed, or some combination thereof. For example, the aft bulkhead 330 may be machined with Computer Numerical Control (CNC) machining that leverages a computer system to precisely control machinery to remove material from a single piece of material. The computer system may generate instructions for controlling the machinery to exacting precision. In another example, the aft bulkhead 330 may be 3D printed with an additive process. Likewise, the 3D printer leverages a computer system for precise control of the 3D printer's components for precise addition of material to build a structure. In one or more embodiments, SLM or DMLS are two example metal additive manufacturing processes that both leverage a laser to scan and selectively fuse metal powder particles together, thereby bonding the metal powder particles into one monolithic structure.

The casing 310, the forward bulkhead 320, and the aft bulkhead 330 may be formed of materials sufficient to withstand the pressure and/or the heat generated from combustion of the propellant within the combustion chamber. For example, the forward bulkhead 320 and/or the aft bulkhead 330 may be constructed from metal, or some metallic alloy. For example, the bulkheads may be constructed from aluminum, titanium, composites, or some combination thereof. In another example, the casing 310 may be constructed, in part, with one or more carbon fiber layers bonded together, e.g., with epoxy.

The propellant grain 350 fills at least a portion of the combustion chamber. The propellant grain 350, when ignited, chemically reacts to combust, thereby creating a chain reaction. As the propellant grain 350 is combusted, resultant gas from the combustion is expelled through the nozzle 340. The propellant grain 350 may be composed of fuel and oxidizer, optionally with a binding agent. The propellant grain 350 may be created through mixing of fuel and oxidizer powder into a solid cake. The selection of the fuel and the oxidizer can be tailored to achieve different combustion profiles. Example fuels that may be selected for use in making the propellant grain 350 include: hexogen, octogen, aluminum, nitrocellulose, etc. Example oxidizers that may be selected for use in making the propellant grain 350 include: ammonium nitrate, ammonium dinitramide, ammonium perchlorate, or potassium nitrate. Example binding agents that may be selected for use in making the propellant grain 350 include a polymeric binder. The propellant grain 350 may further include other chemical agents, e.g., reaction catalysts, plasticizers, stabilizers, or burn rate modifiers (e.g., iron oxide, copper oxide).

In one or more embodiments, the propellant grain 350 is cast into the combustion chamber of the rocket motor 300. In one or more such embodiments, the combustion chamber of the rocket motor 300 may include the inhibitor layer 312 with the topographical features. As such, the propellant grain 350 is cast onto the inhibitor layer 312, inheriting similar topographical features on an external, circumferential surface of the propellant grain 350. In one or more embodiments, the propellant grain 350 is coupled to one or more walls of the combustion chamber. In the embodiment shown, the propellant grain 350 is coupled to the forward bulkhead 320 and an internal surface of the casing 310, but is not coupled to the aft bulkhead 330. In one or more embodiments, the propellant grain 350 does not include a central channel, yielding an increase in propellant load compared to a similarly sized propellant with a central channel. In such embodiments, the propellant grain 350 burns from the aft end of the rocket motor 300 towards the fore end. In one or more embodiments, the propellant grain 350 has a non-planar surface towards an aft end of the propellant grain 350. The non-planar surface may be optimized to control the burn rate of the propellant. In one or more embodiments, the non-planar surface includes a plurality of spokes, radially disposed from the central axis 302, with one or more conical valleys disposed in between adjacent spokes.

In one or more embodiments, the rocket motor 300 includes one or more burn rate enhancing (BRE) wires 355. The BRE wires 355 enhance propellant burning rates. In one or more embodiments, the BRE wires 355 are composed of silver. In other embodiments, other metals with high thermal conductivity may be used. In one or more embodiments, the BRE wires 355 are linear. In other embodiments, the BRE wires 355 may be curved, e.g., forming a helical structure. In one or more embodiments, the BRE wires 355 are partially embedded in the propellant grain 350, i.e., at least a portion of each BRE wire 355 is covered by the propellant grain 350. In effect, only a portion of each BRE wire 355 is exposed to the empty space in the combustion chamber. In one or more embodiments, at least one BRE wire 355 may be positioned parallel to the central axis 302 in a conical valley of the non-planar surface of the propellant grain 350. In the embodiment shown, the propellant grain 350 includes five BRE wires 355 disposed parallel to the central axis 302 and embedded in the five conical valleys of the non-planar surface of the propellant grain 350 towards the aft end. In other embodiments, the rocket motor 300 includes 1, 2, 3, 4, 5, 6, 7, 8, 9, or 10 BRE wires 355. A length of each BRE wire 355 may be less than the length of the propellant, measured along the central axis 302.

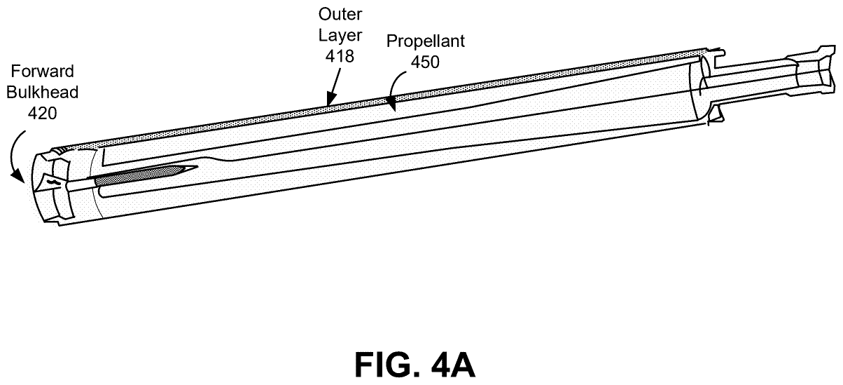

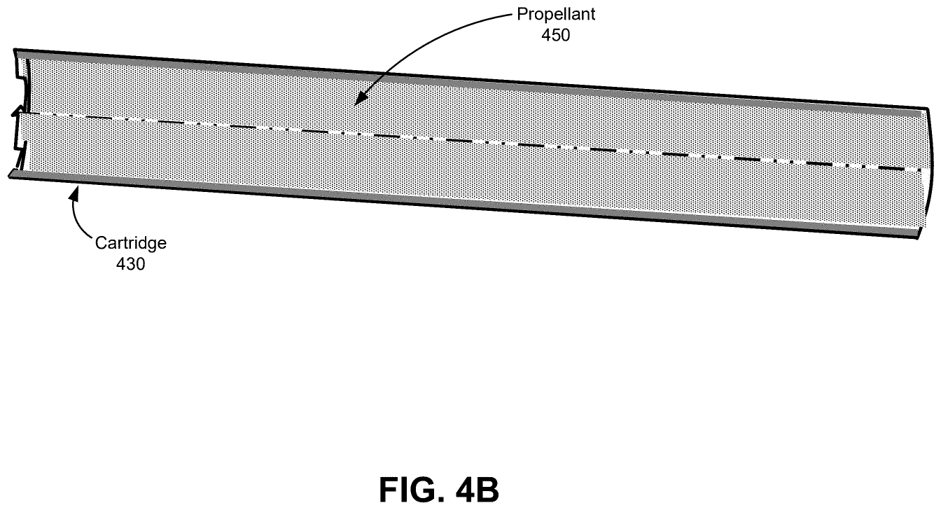

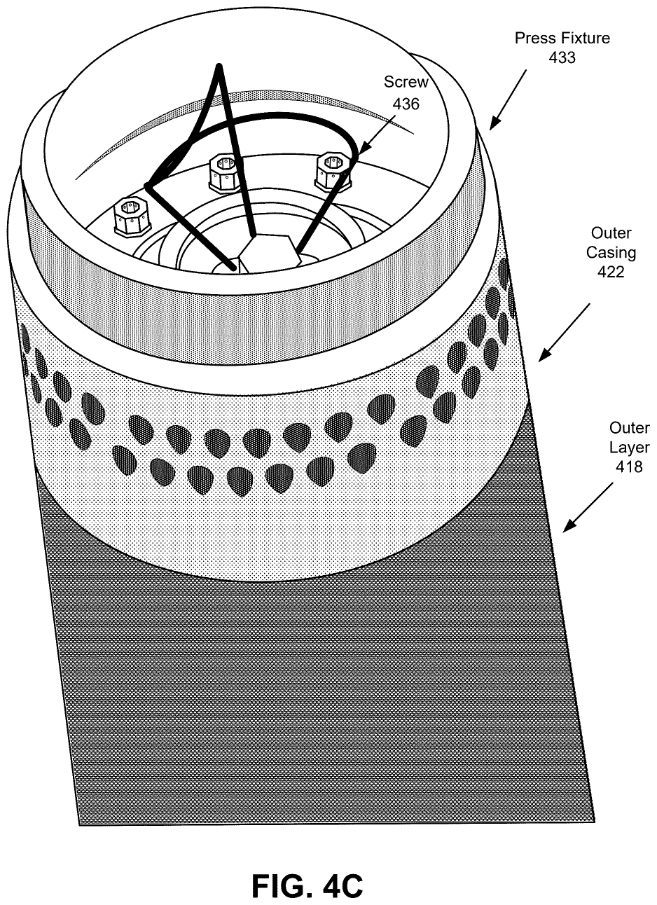

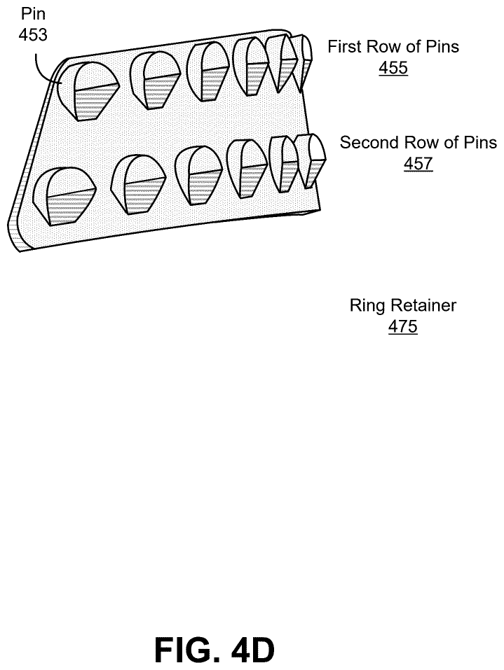

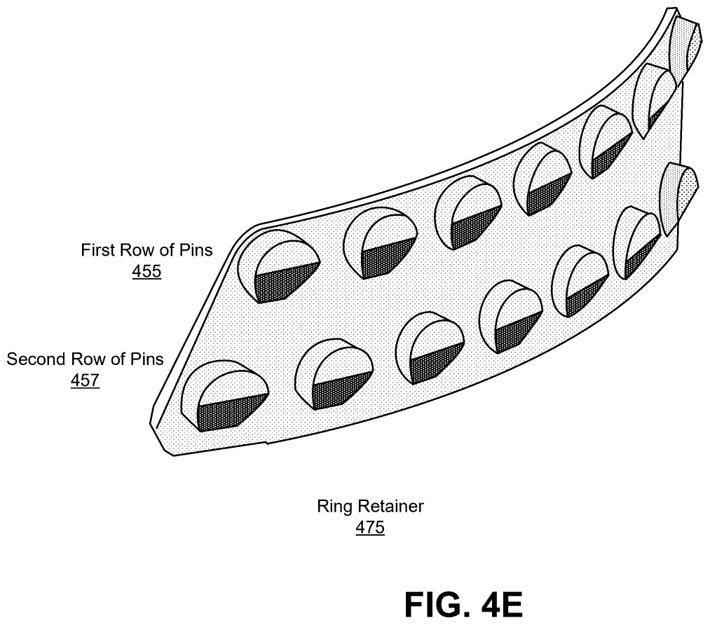

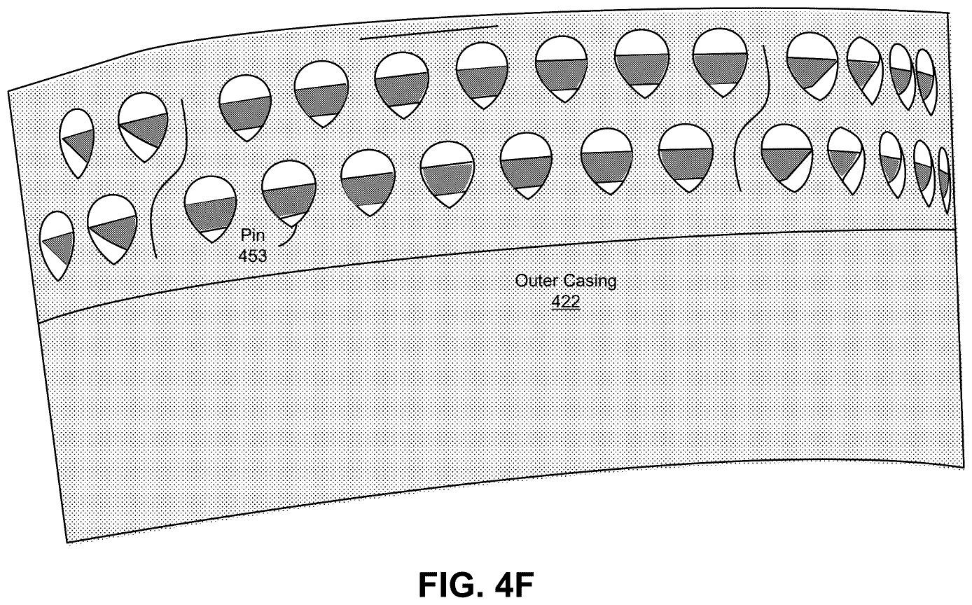

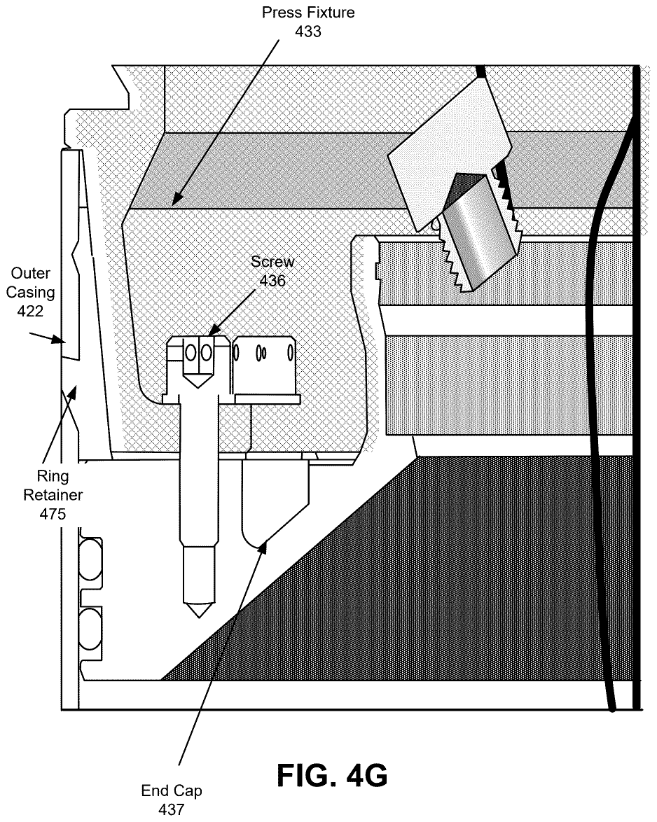

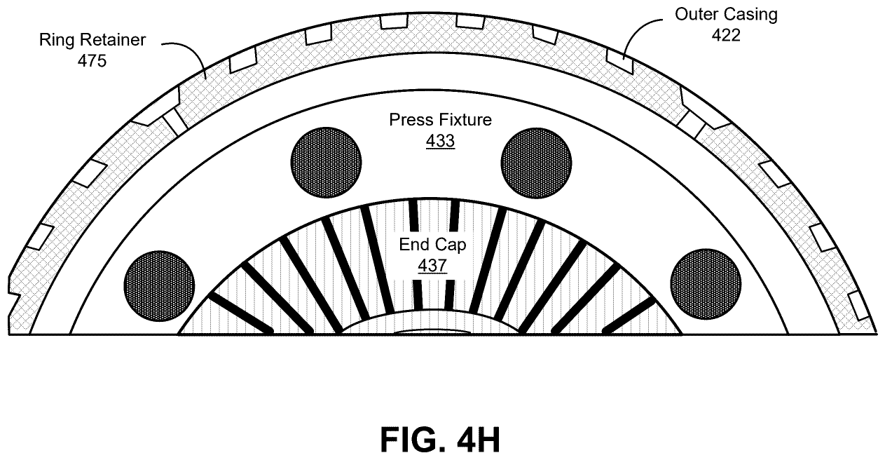

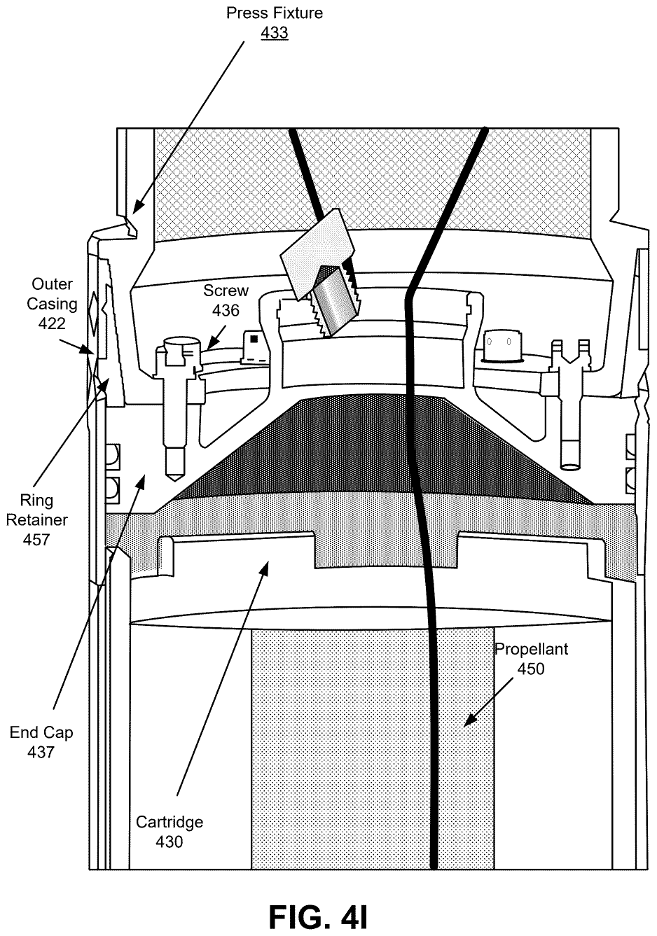

FIGS. 4A-4I illustrate a comprehensive view of the various components and assemblies of a rocket motor 300. In one or more embodiments, the rocket motor is designed for use in rocket propulsion systems. In other embodiments, the motor may be adapted for use in other industries or applications, such as automotive, aerospace, or industrial machinery. For example, the rocket motor could be utilized in systems requiring controlled combustion or high-performance propulsion beyond rocket-based applications. Although the description primarily focuses on rocket motors, the principles, components, and methods discussed may be applicable to other types of motors.

The joint for a rocket motor 300 is configured to provide a secure, load bearing connection enclosing the propellant within the cartridge. The joint for the rocket motor 300 is designed to secure the propellant cartridge during combustion, i.e., under extremely high forces and temperatures.

The cartridge rocket motor 300 forms a combustion chamber within which the propellant is cast. The cartridge includes a joint at the fore end which fixes the end cap of the cartridge in place which allows for removability of the end cap. The cartridge further includes a nozzle positioned at a back end. The joint includes a set of ring retainers 475 with pins that key into engagement holes in the cartridge. The ring retainers 475 are positioned within the cartridge and fixed to the end cap with one or more fasteners, aligning the end cap of the cartridge to secure the ring retainers 475 to the outer casing of the cartridge.

The removable joint is advantageous compared to traditional fastening methods. Foremost, the removable joint maintains a larger outer diameter for the cartridge, which maximizes propellant volume without impacting load carrying capability. Additionally, the removable joint allows for easy serviceability of the rocket motor 300 (e.g., prior to deployment) and, optionally, reusability of the rocket motor 300. The removable joint includes ring retainers that engage with the outer casing, but are not welded to the outer casing. The ease in removing the ring retainers empowers replacing worn or damaged parts of the cartridge, thereby extending the life cycle of the cartridge system. For two, the removable joint maintains the structural integrity of the rocket motor 300. The removable joint maintains the structural integrity of the rocket motor by eliminating the wear and tear from the repeated tightening and loosening of traditional mechanical fasteners. For three, the removable joint provides an avenue for reusability of the rocket motor 300, such that the propellant can be replaced after use of the rocket motor 300 and the rocket motor 300 can be re-assembled for subsequent use.

The ring retainers 475 includes a set of pins that engage with engagement holes in the outer casing, to provide a secure and removable connection between the end cap of the propellant and the outer casing of the cartridge. Further details of the pins are discussed below. The set of pins distribute mechanical loads throughout a circumference of the outer casing, providing for the pins to resist the stress and tension occurring at the fore end during combustion of the rocket motor 300.

FIG. 4A illustrates a cross-sectional view a solid propellant rocket motor 300, in accordance with one or more embodiments. FIG. 4A includes a solid propellant 450 for a substance to produce a force or thrust when ignited. FIG. 4A includes an outer layer 418 enclosing a cartridge propellant. In some embodiments, outer layer 418 is constructed out of a metal alloy material. In one or more embodiments, the outer layer 418 may be constructed from alternative materials, such as polymer-based alloys, carbon fiber composites, or ceramics like silicon carbide. In one or more additional embodiments, the outer layer 418 may be constructed by materials like PEEK or polyimides. The choice of material may vary depending on the specific application and operational requirements of the propellant motor. Further details of the outer layer 418 are described in FIG. 4C. Further details of the forward bulkhead 420 in FIG. 4A are described in FIG. 4C-FIG. 4I.

FIG. 4B illustrates a perspective of a propellant cartridge, according to one or more embodiments. The propellant 450 is cast or molded into the cartridge 430, which is configured to serve as both a containment vessel and a support structure for the propellant. In one or more embodiments, the cartridge 430 features a tubular design, to act as a mold for forming the propellant 450 into a uniform cylindrical grain. In one or more embodiments, the cartridge 430 is constructed of a phenolic material, a heat-resistant insulator. The cartridge 430 is designed to prevent heat generated by the propellant 450 from transferring to the outer layer 418. In one or more embodiments, the cartridge 430 may be constructed of alternative materials such as ceramic materials, polymer-based materials, or composite materials.

In one embodiment, the optimal cartridge 430 may be selected according to the dimensions and characteristics of the propellant 450 grain, where the identification of the propellant 450 grain, shape, and size may affect the efficiency and capacity of the cartridge 430. The grain, shape, and size of the propellant affect how the propellant burns—the larger size of the propellant affects the burn length of the propellant. A larger propellant may lead to a longer burn time. The shape and grain of the propellant may affect how the propellant burns over time. In one embodiment, the cartridge is selected according to the diameter of the propellant to match the diameter of the propellant to properly encase the propellant.

FIG. 4C illustrates a perspective view of a forward bulkhead 420 of the cartridge 430, in accordance with one or more embodiments. FIG. 4C illustrates the outer layer 418, an outer casing 422, a press fixture 433 and a series of screws 436. In one embodiment, the press fixture 433 is coupled onto the propellant cartridge 430 via a series of screws 436. The press fixture 433 is a component of the cartridge 430 to couple the end cap 437 to the outer layer 418. Further details of the press fixture 433 are described in FIG. 4G and FIG. 4I. The shape of the outer layer 418 can vary based on design requirements and operational considerations. In one embodiment, the outer layer 418 is tubular, complementing the shape of the cartridge 430 and the propellant 450 grain. In alternative embodiments, the outer layer 418 may take other shapes, such as rectangular, elliptical, or any form suitable to accommodate for specific configurations or performance objectives of the propellant motor. The outer layer 418 includes an outer casing 422. In one or more embodiments, the outer casing 422 is an additive piece welded onto the outer layer 418. Further details of the outer casing 422 is described in FIG. 4F.

FIG. 4D illustrates a perspective view of a ring retainer 475, in accordance with one or more embodiments. The ring retainer 475 serves as a structural component designed to secure, in conjunction with the press fixture and the end cap, the propellant within the cartridge. The ring retainer 475 is designed to withstand the extreme combustion of the rocket motor 300. The ring retainer 475 is constructed of materials that can withstand thermal, mechanical, and load-bearing requirements. In one or more embodiments, the ring retainer 475 may be constructed of Inconel metal alloy. In one or more embodiments, the ring retainer 475 may be constructed of alternative materials such as titanium, aluminum alloys, or polymer.

In one or more embodiments, the ring retainer 475 may be 3D printed, e.g., through an additive printing process. The 3D printer leverages a computer system for precise control of the 3D printer's components for precise addition of material to build a structure. In one or more embodiments, Selective Laser Melting (SLM) or Direct Metal Laser Sintering (DMLS) are two example metal additive manufacturing processes that both leverage a laser to scan and selectively fuse metal powder particles together, thereby bonding the set of pins 453 to the base to form the ring retainer 475 into one monolithic structure.

In some embodiments, the ring retainer 475 has a curvature surface. A plurality of groups of pins 453 may protrude from the convex side of the curvature surface. The pins 453 may be grouped in any suitable manner, such as in rows as shown in FIG. 4D and FIG. 4E or in series, segments, sections, or any suitable groupings, symmetric or asymmetrical, regular, or irregular.

In one or more embodiments, the ring retainer 475 includes a first row of pins 455 and a second row of pins 457. The pins in each row may have even or staggered spacing. In the current implementation, the first row of pins 455 and the second row of pins 457 have even spacing of their pins. The first row of pins 455 and the second row of pins 457 are placed parallel to one another. This arrangement allows for a uniform load distribution, where each pin within a row bears an approximately equal portion of the force applied to the system. In some embodiments, the rows of pins may be skew. In one or more embodiments, the spacing in the first row is different from the spacing in the second row. In other embodiments, one row may have even spacing with another row having uneven spacing. In one or more embodiments, one row may have less pins than another row. In other embodiments, there may be three or more rows of pins.

In one or more embodiments, the series of pins may be arranged with an offset spacing between the first row of pins 455 and the second row of pins 457. The second row of pins 457 has an offset arrangement relative to the first row of pins 455 where certain areas may carry more load while others experience reduced load. In this arrangement, each pin in the first row of pins 455 is longitudinally aligned with the spacing between pins of the second row of pins 457. While in operation, the first row of pins 455 initially bears the increasing load, which is then progressively transferred to the second row of pins 457 as the load increases. The transfer process causes peaks at specific contact points to ensure the load is distributed across the series of rows of pins efficiently.

In one or more embodiments, the ring retainer 475 may include more than two rows of pins to further enhance load distribution. The ring retainer 475 includes multiple rows of pins to support the load during combustion of the propellant in the cartridge 430. The multiple rows of pins distribute the weight load and allows for a reduction on stress onto individual rows of pins. In one or more embodiments, the ring retainer 475 includes more than two rows of pins, which further affects the weight load distribution and stress applied to the rows of pins.

In FIG. 4D, for the first row of pins 455, in one embodiment, the ring retainer 475 includes a set of seven pins, but in an alternative embodiment, the first row of pins 455 may include any number of pins. Similarly, in FIG. 4D the second row of pins 457, in one embodiment, the ring retainer 475 includes a set of seven pins, but in an alternative embodiment, the second row of pins 457 may include any number of pins. In one embodiment, the number of pins in the first row of pins 455 is equal to the number of pins in the second row of pins 457. In an alternative embodiment, the number of pins in the first row of pins 455 is not equal to the number of pins in the second row of pins 457. The number of pins within the row of pins affect the load distribution and stress. A greater number of pins within the row spreads the applied force across a greater number of pins, reducing the stress on each individual pin. This may help distribute weight more evenly. However, an excess number of pins may affect the overall mass of the ring retainer 475, affecting the center of gravity of the ring retainer 475. The number of pins also affects the spacing width between pins, such that diminished spacing results in closer spacing of the engagement holes in the outer casing. The diminished spacing between the engagement holes in the outer casing can lessen the load bearing ability of the engagement holes. Thus, an optimal balance between the number of pins and the spacing between pins within the row is important.

A pin 453 is raised from a surface of the ring retainer 475 and may take any suitable shape that allows the pin 453 to serve as a retaining member. In some embodiments, the pin 453 may take the shape of a droplet shape that has a first portion that is semi-circular and a second portion that is triangular. In some embodiments, the second portion of the pin has a height that tapers down, blending into the curvature surface of the ring retainer 475. In some embodiments, the pin 453 is a volumetric structure that is a component of the ring retainer 475. For each pin 453, the droplet shape of the pin 453 includes a first portion having a semi-circular shape and a second portion coupled to the first portion with a triangular shape. The height of pin 453 tapering from the first portion into the second portion. The height of the pin 453 of the first portion being the width of the outer casing of the cartridge 430. Height of each pin is measured from the curvature surface of the ring retainer and extending away from the curvature surface.. The pins 453 may be formed on the curvature surface of the ring retainer 475 in any suitable manner, such as an integral formation that is generated by additive manufacturing, injection molding, welding, or another suitable method.

In one or more embodiments, the shape of the pin 453 may be of a circular shape, square shape, diamond shape, hexagonal shape, octagonal shape, or a pentagonal shape. The circular shape of the pin 453 has a symmetrical shape, which evenly distributes loads and minimizes stress concentrations. In one or more embodiments, the shape of the pin 453 may be of a square shape. The square shape of the pin 453 has a flat symmetrical shape to distribute the load. The diamond shape of the pin 453 may introduce new stress tensions between the edges and distributes grip along the edges. Additionally, the geometric variations, such as hexagonal, octagonal, and pentagonal pins, offer a uniform distributing of load while still maintaining some degree of anti-rotation properties.

In one or more embodiments, the pins 453 extend outwardly from the curved surface of the ring retainer 475 and are parallel to one another. By extending the pins 453 in a parallel manner, the pins 453 remain evenly spaced to make consistent contact while coupling the outer layer 418 to the pins 453. This parallel arrangement distributes the pins 453 evenly to ensure uniform alignment with the ring retainer 475. If the pins 453 extended radially, the pins 453 could not fit into the engagement holes. Expanding the engagement holes in the outer casing would lead to increased movement between the pins and the engagement holes when coupled, which could lead to increased wear and stress between the components of the joint.

FIG. 4E illustrates an alternative perspective view of a ring retainer 475, in accordance with one or more embodiments.

FIG. 4F illustrates a perspective view of a ring retainer 475 fastened to an outer casing, according to one or more embodiments.

In one or more embodiments, the outer casing 422 is constructed of Inconel material. In an alternative embodiment, the outer casing 422 may be constructed of alternative materials such as titanium, aluminum alloys, or polymer according to the application of the outer casing 422.

In one or more embodiments, the outer casing 422 is designed with a dual-portion structure, consisting of an aft portion and a fore portion to complement the ring retainer 475.

The aft portion of the outer casing 422 is tubular in shape, complementing the shape of the propellant 450. In alternative embodiments, the outer casing 422 may take other shapes, such as rectangular, elliptical, or any form suitable to accommodate specific configurations or performance objectives of the system. In one embodiment, the aft portion of the outer casing 422 is welded to the tubular outer layer 418. In one or more embodiments, the aft portion of the outer casing 422 is fit to the tubular outer layer 418 by using mechanical fasteners, adhesive bonding, press fit joints, or clamping.

In one embodiment, the fore portion of the outer casing 422 is designed with a series of engagement holes specifically configured to fit the shape and arrangement of the pins 453. The engagement holes may be complementary in shape to the pins. In one embodiment, the series of engagement holes are reciprocally coupled to the arrangement of the pins 453 to create an even load translation between the pins 453 and the outer casing 422. The pin 453 is coupled into a tight and stable fit to distribute the weight of the cartridge 430 load. The interlocking nature of this coupling leads to simplified assembly and easy removability. The outer casing 422 provides a stable anchor for the pins 453, preventing the pins 453 from shifting or dislodging during operation. In one or more embodiments, the engagement holes in the outer casing 422 are tailored to effectively match the dimensions, spacing, and orientation of the pins 453 to create a load-balancing relationship between the joint. During combustion of the propellant, gaseous exhaust from combustion of the propellant expands to create high pressure within the combustion chamber of the cartridge 430. The high pressure applies an axial force on the end cap (in the fore direction), and thereby the joint. The force applied to the end cap transfers to the ring retainers, which in turn transfers to the coupling between the pins 453 and the outer casing 422. Thus, the engagement holes of the outer casing 422 bear the ultimate load from the combustion of the propellant.

The computer system may generate instructions for controlling the machinery to exacting precision. In one embodiment, the outer casing 422 may be 3D printed with an additive process. Likewise, the 3D printer leverages a computer system for precise control of the 3D printer's components for precise addition of material to build a structure. In one or more embodiments, Selective Laser Melting (SLM) or Direct Metal Laser Sintering (DMLS) are two example metal additive manufacturing processes that both leverage a laser to fuse metal powder particles together, thereby bonding the metal powder particles into one monolithic structure.

FIG. 4G illustrates a cross-sectional view of the forward bulkhead 420 of FIG. 4C, according to one or more embodiments. The forward bulkhead 420 of FIG. 4C, includes an end cap 437. In one or more embodiments, the end cap 437 is a tubular-shaped component designed to effectively “close out” or seal the propellant cartridge 430. In an alternative embodiment, the end cap 437 may be any alternative geometry that facilitates its secure attachment to the cartridge 430, ensuring a proper fit to seal the open end of the cartridge 430.

In one embodiment, a press fixture 433 may be a component of a rocket system that is mechanically connected to the propellant cartridge 430 through a joint. The press fixture 433 may be designed as a cylindrical part with a connection end specifically shaped to apply pressure to the ring retainer 475, forcing it outward. The base surface of the press fixture 433, in one embodiment, comprises a lateral portion with a frustum-like shape that is configured to engage with the sloped inner surface of the ring retainer 475. The base surface of the press fixture 433 comprises a bottom portion at the aft end of the press fixture 433 that is secured to the end cap of the cartridge 430. The base surface of the press fixture 433 may include a series of screw holes or other types of connection holes suitable for securing the press fixture 433 to the end cap 437. In one embodiment, this series of screw holes may accommodate fasteners, such as screw 436, which bind the press fixture 433 securely to the end cap 437. The fasteners are any mechanical components used to secure the press fixture 433 to the end cap 437. In one or more embodiments, a series of alternative fasteners to screws 436 may be used instead such as rivets, bolts and nuts, adhesives, pins, clamps, etc. The fasteners may be removable, empowering decoupling of the ring retainers 475 from the outer casing.

In one embodiment, the lateral portion of the base surface of the press fixture 433 may feature a sloped lateral surface that tapers toward the base of the press fixture 433. The sloped surface may interact with the ring retainer 475 to create a precise outward movement when the press fixture 433 is engaged. By way of example, the sloped lateral portion of the press fixture 433 may be designed to complement the slope of the ring retainer 475. In one embodiment, the ring retainer 475 includes an aft end that gradually increases in thickness to ensure a secure press-fit engagement with the lateral portion of the press fixture 433. As the press fixture 433 is fastened to the end cap 437, the sloped lateral surface of the press fixture 433 applies an outward force on the ring retainer 475. This outward force may cause the pins of the ring retainer 475 to extend and engage with the engagement holes located on the outer casing 422.

FIG. 4H illustrates a perspective view of the forward bulkhead of FIG. 4C, according to one or more embodiments. FIG. 4H includes a perspective top-down view of the end cap 437, the press fixture 433, the ring retainer 475, and the outer casing 422. As shown in FIG. 4H, pins on one ring retainer 475 extend from the outer curved surface in a parallel manner, i.e., most of the outer pins are skew to the radial axis from a central channel of the rocket motor.

In one embodiment, the ring retainer 475 may arrange a series of pins 453 to be configured parallel to one another. As illustrated in FIG. 4H, the ring retainer 475 arranges the series of pins 453 parallel to one another. As illustrated, the parallel configuration of pins 453 empower installation of the ring retainer 475 into the cartridge 430. The series of pins 453 are parallel to the ring retainer 475 to maintain consistent fit between the ring retainer 475 and cartridge 430. If the series of pins 453 were to be aligned radially or at an angle to the ring retainer 475, there would be a physical constraint preventing the ring retainer 475 from installation into the cartridge 430.

In one embodiment, the ring retainers 475 have angled sides to form a parallelogram-like shape. The angled side of the ring retainer 475 creates a press-fit engagement to create a wedging effect, ensuring a tight fit between the ring retainers 475. The parallelogram-like shape is configured to securely fit with the lateral portion of the press fixture 433, while maintaining the self-supporting geometry between the outer casing 422 and the set of pins 453.

As illustrated in FIG. 4H, the set of ring retainers 475 may include 5 or more ring retainers 475 that are aligned about the edge of the press fixture 433. The size and dimensions of the ring retainers 475 may vary. In some embodiments, larger ring retainers 475 may be used to increase surface contact with the outer layer 418, providing additional structural support. Conversely, smaller ring retainers 475 may be beneficial in cartridges where load distribution is a priority. Thus, the number of ring retainers can be adjusted depending on the size of the ring retainer 475, with configurations that include five, six, or more retainers to optimize for different applications.

FIG. 4I illustrates a second perspective cross-sectional view of the forward bulkhead 420 of FIG. 4C, according to one or more embodiments. FIG. 4I discloses a view of the forward bulkhead of the rocket motor including a cross-sectional view of the outer casing 422, press fixture 433, screw 436, ring retainer 475, end cap 437, cartridge 430, and the propellant 450.

In one embodiment, a manufacturer may assemble the cartridge 430 to enclose the propellant 450 with the following workflow outlined below. The cartridge 430 includes an outer casing 422, with a set of engagement holes to match the shape of the pins of the ring retainer 475, that is welded onto the outer layer 418 of the cartridge 430. The cartridge 430 is sized with a first diameter, sized for the volume of propellant 450 to be cast into the rocket motor 300. The end cap 437 is affixed to the fore end of the outer casing 422, i.e., to seal the propellant 450. A set of five ring retainers 475 are aligned along the end cap 437 and engaged into the engagement holes in the outer casing 422. The press fixture 433 is then fastened to the end cap 437 with a set of mechanical fasteners, effectively closing off the propellant 450. The aft end also includes an aft bulkhead with nozzle. Any additional accessories may be affixed or coupled. The rocket motor 300 may further be inspected for quality assurance prior to deployment.

In one embodiment, following a combustion reaction of the propellant 450 within the rocket motor, a manufacturer may disassemble the rocket motor for reusability of the rocket motor. The manufacturer disassembles the set of fasteners securing the press fixture 433 to the end cap 437. The set of five ring retainers 475, aligned along the end cap 437, are removed from the engagement holes in the outer casing 422 of the rocket motor. The manufacturer removes the end cap 437 sealing the propellant 450. The manufacturer may remove any debris or other remnant in the cartridge 430. The manufacturer may clean the combustion chamber prior to recasting of propellant. The manufacturer may cast new propellant 450 into the cartridge of the rocket motor 300. The end cap 437 is re-affixed to the fore end of the outer casing 422 to seal the new propellant 450. The set of five ring retainers 475 are aligned along the end cap 437 and engaged into the engagement holes in the outer casing 422. The press fixture 433 is then re-fastened to the end cap 437 with the set of mechanical fasteners, effectively closing off the new propellant 450. The reassembled rocket motor is ready for subsequent combustion.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor may comprise one or more subprocessing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present); A is false (or not present) and B is true (or present); and both An and B are true (or present). Similarly, a condition “A, B, or C” is satisfied by any combination of A, B, and C being true (or present). As a not-limiting example, the condition “A, B, or C” is satisfied when An and B are true (or present) and C is false (or not present). Similarly, as another not-limiting example, the condition “A, B, or C” is satisfied when A is true (or present) and B and C are false (or not present).

What is claimed is:

1. A joint for a rocket motor comprising:
a casing of a cylindrical shape, the casing comprising a set of engagement holes disposed circumferentially around one end of the casing;
a plurality of ring retainers coupled to an inner surface of the casing, each ring retainer comprising:
a set of pins extending from an outer surface of the ring retainer, wherein the set of pins of the ring retainer extend in a parallel configuration to engage with a subset of the engagement holes of the casing.

2. The joint of claim 1, wherein each ring retainer includes a sloped inner surface opposite the outer surface, the joint further comprising:
a press fixture configured to secure a cartridge of the rocket motor inside the casing, the press fixture comprising:
a lateral portion with a frustum shape configured to engage with the sloped inner surfaces of the ring retainers;
a bottom portion coupled to an aft end of the lateral portion and securable to an end cap of the cartridge.

3. The joint of claim 2, wherein the press fixture further comprises a set of fasteners for securing the press fixture to the end cap of the cartridge.

4. The joint of claim 3, wherein the plurality of ring fasteners includes one or more of: screws, nuts and bolts, adhesives, pins, and clamps.

5. The joint of claim 2, wherein the lateral portion of the press fixture comprises a sloped outer surface complementing the sloped inner surface of the ring retainer to apply an outward force to the ring retainers.

6. The joint of claim 2, wherein the bottom portion of the press fixture has an annular shape.

7. The joint of claim 1, wherein the set of pins on each ring retainer includes two or more rows of pins parallel to one another.

8. The joint of claim 1, wherein the set of pins on each ring retainer includes two or more rows of pins offset to one another.

9. The joint of claim 1, wherein each pin has a droplet shape comprising:
a first portion having a semi-circular shape; and
a second portion coupled to the first portion, the second portion having a triangular shape.

10. The joint of claim 9, wherein a height of each pin tapers from the first portion to the second portion.

11. The joint of claim 10, wherein a height of the first portion is a width of the casing.

12. The joint of claim 1, wherein each engagement hole has a droplet shape complementing the droplet shape of the pins.

13. A rocket motor comprising:
a joint comprising:
a casing of a cylindrical shape, the casing comprising a set of engagement holes disposed circumferentially around one end of the casing;
a plurality of ring retainers coupled to an inner surface of the casing, each ring retainer comprising:
a set of pins extending from an outer surface of the ring retainer, wherein the set of pins of the ring retainer extend in a parallel configuration to engage with a subset of the engagement holes of the casing.

14. The rocket motor of claim 13, wherein each ring retainer includes a sloped inner surface opposite the outer surface, the joint further comprising:
a press fixture configured to secure a cartridge of the rocket motor inside the casing, the press fixture comprising:
a lateral portion with a frustum shape configured to engage with the sloped inner surfaces of the ring retainers;
a bottom portion coupled to an aft end of the lateral portion and securable to an end cap of the cartridge.

15. The rocket motor of claim 14, wherein the press fixture further comprises a set of fasteners for securing the press fixture to the end cap of the cartridge.

16. The rocket motor of claim 14, wherein the lateral portion of the press fixture comprises a sloped outer surface complementing the sloped inner surface of the ring retainer to apply an outward force to the ring retainers.

17. The rocket motor of claim 14, wherein the bottom portion of the press fixture has an annular shape.

18. The rocket motor of claim 13, wherein the set of pins on each ring retainer includes two or more rows of pins parallel to one another.

19. The rocket motor of claim 13, wherein the set of pins on each ring retainer includes two or more rows of pins offset to one another.

20. The rocket motor of claim 13, wherein each pin has a droplet shape comprising:
a first portion having a semi-circular shape; and
a second portion coupled to the first portion, the second portion having a triangular shape.
